(19) United States
(12) Patent Application Publication
(10) Pub. No.: US 2024/0339131 A1
(43) Pub. Date: Oct. 10, 2024

(54) SPINDLE MOTOR

(71) Applicant: MINEBEA MITSUMI Inc., Nagano (JP)

(72) Inventor: Akihiko SUZUKI, Kitasaku-gun (JP)

(21) Appl. No.: 18/623,283

(22) Filed: Apr. 1, 2024

(30) Foreign Application Priority Data
Apr. 6, 2023 (JP) 2023-062273

(51) Int. Cl. G11B 19/20; C09C 1/48; G11B 33/12

(52) U.S. Cl. CPC G11B 19/2009; C09C 1/48; G11B 33/12

(57) ABSTRACT

Provided are a base member at least partially covered with a coating film, the coating film being an electrodeposition coating film containing no carbon black, a spindle motor including the base member, and a disk drive apparatus including the spindle motor.

### CROSS-REFERENCE TO RELATED APPLICATIONS

This application claims the benefit of priority to Japanese Patent Application Number 2023-062273 filed on Apr. 6, 2023. The entire contents of the above-identified application are hereby incorporated by reference.

### TECHNICAL FIELD

The disclosure relates to a base member of an electronic apparatus, such as a disk drive apparatus, and relates to a spindle motor using the base member.

### BACKGROUND

A base member (also referred to as a base plate) of a disk drive apparatus is generally manufactured by die casting of aluminum, and electrodeposition coating is applied on a surface of the base member to prevent generation of dust or the like from the surface of the base member (for example, JP 2002-275413 A).

The electrodeposition coating for the base member is applied not only to a known disk drive apparatus but also, for example, to a sealed disk drive apparatus containing a low-density gas, such as helium gas, sealed inside the apparatus, a disk drive apparatus employing a heat-assisted magnetic recording (HAMR) system as a next-generation recording technology, and the like (JP 5049017 B and the like).

In such electrodeposition coating for the base member, in addition to a binder component, a coating is applied which contains a pigment component, such as a coloring pigment, such as carbon black, or an extender pigment, such as kaolin, as a component for imparting color, hiding, or the like to a coating film.

### SUMMARY

Generation of a foreign matter resulting from the electrodeposition coating of the base member, such as generation of dust due to peeling off of carbon black of the coating film, is considered to be one cause of a failure of the disk drive apparatus. The carbon black that has peeled off may be caught in a read/write head portion of the disk drive apparatus as dust, possibly causing mechanical damage.

An object of the disclosure is to provide a base member that allows prevention of the mechanical damage or the like of the disk drive apparatus caused by peeling off of carbon black in an electrodeposition coating film.

One aspect of the disclosure relates to a base member at least partially covered with a coating film. The coating film is an electrodeposition coating film containing no carbon black.

The disclosure also relates to a spindle motor including the base member and a disk drive apparatus including the spindle motor.

### BRIEF DESCRIPTION OF DRAWINGS

FIGS. 1A and 1B are schematic views for illustrating an example of a base member according to the disclosure, wherein FIG. 1A is a plan view and FIG. 1B is a perspective view.

FIG. 2 is a conceptual view for illustrating an example of a main component structure of a spindle motor of the disclosure.

FIG. 3 is a schematic view for illustrating an example of the structure of a drive apparatus (disk drive apparatus) provided with the spindle motor of the disclosure.

FIGS. 4A and 4B are appearance photographs (FIG. 4A is after overbaking, and FIG. 4B is before overbaking) of a hard disk case with a cationic electrodeposition paint (1) (without carbon black) applied.

FIGS. 5A and 5B are appearance photographs (FIG. 5A is after overbaking, and FIG. 5B is before overbaking) of a hard disk case with a cationic electrodeposition paint (2) (without carbon black and an extender pigment) applied.

FIGS. 6A and 6B are enlarged photographs of surfaces of the hard disk cases with the cationic electrodeposition paint (1) and the cationic electrodeposition paint (2) applied (FIG. 6A: cationic electrodeposition paint (1) ((I) is before overbaking, and (ii) is after overbaking), and FIG. 6B: cationic electrodeposition paint (2) ((I) is before overbaking, and (ii) is after overbaking)).

### DESCRIPTION OF EMBODIMENTS

A cause of occurrence of a read/write error in a hard disk drive (HDD) includes a foreign matter entering into a disk drive apparatus. When dust and a volatile component from lubricating oil adhere to a magnetic disk or a magnetic head, normal reading and writing cannot be performed, and this becomes one cause of the read/write error. In addition, when the dust and the volatile component from lubricating oil are caught between the magnetic disk and the magnetic head as foreign matters, mechanical damage is possibly caused.

While the inventors were studying such an inclusion of various foreign matters, they came up with a possibility that carbon black contained in a coating film fallen off in the disk drive apparatus using a base member with an electrodeposition coating applied.

In addition to a coloring pigment, such as carbon black, an extender pigment, such as kaolin, also having a component contributing to the fluidity (extensibility, adhesiveness, and the like) of the paint and the strength of the film, is generally blended in the paint used for the electrodeposition coating. Since kaolin has a shape of a hexagonal plate-like structure, it is considered to be able to impart smoothness to the coating film. Therefore, as compared to carbon black, kaolin is considered to provide better adhesion of a formed coating film to a substrate and to have a smaller protrusion from the coating film, and is considered to be less likely to peel off from the coating film.

Based on these reasons, the inventors have studied the structure of an electrodeposition coating film containing no carbon black against the inclusion of the foreign matters derived from the electrodeposition coating.

However, in the aspect of a film containing no carbon black (black pigment), the color of the base member (aluminum or the like) as a base or the paint (resin) itself appears on the surface, resulting in an aspect of color unevenness occurring on the surface of the base member. Although the color unevenness of the surface does not affect the performance, it results in an undesirable appearance of a product.

In view of these problems, the inventors have found that overbaking the electrodeposition coating film containing no carbon black provides an aspect of an entirely colored surface, thereby providing a good appearance.

The aspect of the base member having the overbaked electrodeposition coating film may provide not only the above-described aspect of improved appearance of the surface but also a further advantageous effect, particularly in the base member of an HDD employing a heat-assisted magnetic recording (HAMR) system.

In the case of the HDD employing the heat-assisted magnetic recording (HAMR) system as the next-generation recording technology, a temperature of a head portion of an actuator may locally reach a high temperature of 400° C. Therefore, even if a low-volatile component is employed to reduce the volatile component of the lubricating oil described above, the amount of volatilization cannot be reduced, and it may be inevitable that the volatile component adheres to the disk or the like as the foreign matter.

On the other hand, in an environment at a high temperature of 400° C. as in the HAMR system, organic impurities, such as the volatile component, can be expected to be decomposed. However, under such a high temperature, oxidation of an organic compound present in the apparatus may occur before decomposition of the impurities, causing oxygen present in the disk apparatus to be consumed first, and as a result, it is undeniable that the decomposition of the impurities may be insufficient.

As another candidate for the organic compound consuming oxygen, a coating (coating film) of the base member applied to prevent dust can be considered. Then, as one of the aspects of the coating film of the base member that is less likely to consume oxygen (preventing uptake of oxygen), the inventors have found the aspect of the overbaked coating film described above, for example, the overbaked electrodeposition coating film.

As described above, in the HDD employing the heat-assisted magnetic recording (HAMR) system, the overbaked electrodeposition coating film not only has a good appearance of the surface but also has an aspect of the coating film less likely to consume oxygen present in the disk apparatus. Therefore, the oxygen sufficiently contributes to the decomposition of the organic impurities, and as a result, the original effect of the disclosure of suppression of the adhesion of impurities (foreign matters) to the disk or the like can also be expected.

The base member according to the disclosure is described below in detail.

The base member (also referred to as a base plate or a base substrate) according to the disclosure is directed to a base member for a disk drive apparatus. The base member is at least partially covered with a coating film, and in particular, the coating film is an electrodeposition coating film containing no carbon black.

The coating film of the base member is formed by electrodeposition coating, and as a coating film-forming material used here, for example, a coating film-forming material (paint) containing a resin containing an epoxy-based resin can be used. In an embodiment, for example, as described later, the coating film can be formed by using a cationic electrodeposition paint containing an epoxy-based resin or an epoxy-polyamide-based resin as a binder component and employing an electrodeposition coating method generally used for manufacturing the base member.

These paints may generally contain pigments, such as coloring pigments, extender pigments, and rust preventive pigments. As the coloring pigments, black pigments, such as carbon black (but not contained in the disclosure), acetylene black, graphite, iron black, and aniline black, and white pigments, such as titanium white, zinc oxide, lithopone, zinc sulfide, and antimony white are used. Examples of the extender pigments include clay, mica, baryta, kaolin, talc, calcium carbonate, silica, barium sulfate, alumina white, and aluminum silicate. Examples of the rust preventive pigments include iron phosphate, aluminum phosphate, calcium phosphate, aluminum molybdate, calcium molybdate, aluminum phosphomolybdate, aluminum dihydrogen tripolyphosphate, and zinc oxide.

Specifically, the cationic electrodeposition paint contains a main agent and a curing agent as a thermosetting resin composition which is the binder component.

An example of the main agent includes a cationized resin, and from the viewpoint of forming the electrodeposition coating, the cationized resin can be an aqueous resin that exhibits water dispersibility. Examples of the cationized resin include an epoxy resin (amine-modified epoxy resin, epoxy-polyamide-based resin, or the like), an amine-modified polyurethane polyol resin, an amine-modified polybutadiene resin, an amine-modified acrylic resin, a sulfonium group-containing resin system, and a phosphonium group-containing resin system.

Examples of the curing agent include a blocked isocyanate curing agent, such as a compound produced by blocking an alicyclic isocyanate, a compound produced by blocking an isocyanate having an aromatic ring, and a mixture of thereof. More specifically, the curing agent can be a compound produced by blocking an alicyclic isocyanate with an oxime, a compound produced by blocking an isocyanate having an aromatic ring with a lower alcohol, or a mixture thereof.

The cationic electrodeposition paint can contain a urethane cleavage catalyst in order to adjust the curability of the binder component. However, in the coating of electronic parts and the like targeted by the disclosure, it is preferable not to use a tin compound (for example, dibutyltin dilaurate or dibutyltin oxide) that is volatile from the coating film or a compound that remains in a cured coating film even after the curing process and gradually volatilizes as they increase an amount of outgas of the cured coating film.

The cationic electrodeposition paint can contain, for example, an organozinc compound that can function as a curing catalyst for a curing system of an epoxy resin and a blocked isocyanate. The organozinc compound can be introduced into the paint as part of a neutralizing agent or as a pigment. Here, the neutralizing agent refers to a component that binds to a cationic group contained in the cationized resin to form a salt, thus allowing the cationized resin to be dispersed in an aqueous medium.

As the part of the neutralizing agent, zinc acetate, zinc lactate, or the like can be used. As the pigment, zinc molybdate, zinc cyanide, zinc oxide, zinc phosphate, zinc phosphomolybdate, and the like can be contained.

However, from the viewpoint of the curability of the coating film, an amount (concentration) of zinc when blended as metal ions can be about 50 ppm or more based on a total amount of the cationic electrodeposition paint.

The cationic electrodeposition paint may be used in combination with another commonly used neutralizing agent. Examples of the neutralizing agent that can be used include inorganic acids and organic acids, such as hydrochloric acid, formic acid, acetic acid, and lactic acid.

In addition to the binder component, the pigment component, the neutralizing agent, and the like, the cationic electrodeposition paint can further contain components usually contained in the cationic electrodeposition paint in amounts usually used. Examples of such components can include gel fine particles, a viscosity modifier, a surfactant, an antioxidant, and an ultraviolet absorber.

In one aspect, the coating film can be an overbaked electrodeposition coating film, and in this case, the electrodeposition coating film can be a film containing an epoxy resin, that is, a film produced by overbaking the coating film containing an epoxy resin and formed by the electrodeposition coating.

Overbaking is understood here to mean the baking of a coating film-forming material (coating material) by supplying energy greater than energy required for desired crosslinking (that is, curing). The overbaking can be caused by excessive heating (baking) time and/or heating (baking) temperature.

For example, in the film containing an epoxy resin, when the heating (baking) temperature required for the coating material is exceeded by 5° C., more particularly 10° C. or more, and/or when the heating (baking) time is exceeded by 20%, the overbaking is presumed to occur. When the heating (baking) temperature is employed as a condition for the overbaking, the overbaking can be expected to proceed quickly, causing industrial advantages.

Various factors are considered for the relationship between the overbaking of the electrodeposition coating film described above and a mechanism for suppressing an uptake quantity of oxygen. For example, overbaking a film containing a resin or the like may result in more crosslinks (bonds) being formed than by predetermined baking. Due to the overbaking (formation of crosslinks), the number of positions at which crosslinks can be formed is reduced, resulting in, for example, suppression of uptake of oxygen atoms contributing to crosslink formation.

The overbaking may rupture (cleave) again crosslinks (bonds) present between molecules constituting the coating film. The cleavage position of the bond may change the light absorption wavelength or the amount of light absorption of the coating film. As a result, the chromaticity of the coating film may be changed as compared to the chromaticity before overbaking, and the appearance of the coating film is considered to be changed.

In the base member for the disk drive apparatus according to the disclosure, the manufacturing method of the base member is not particularly limited.

For example, at least a part of the base member is first coated by the electrodeposition coating. The coating is performed with, for example, a paint containing an epoxy resin. As the paint containing an epoxy resin, for example, a paint containing an epoxy-based resin or an epoxy-polyamide-based resin can be used, but the paint is not limited to them. While the paint may contain the above-described pigments such as the coloring pigments, extender pigments, and rust preventive pigments, the paint does not contain carbon black in the disclosure.

In an embodiment, the base member is immersed in a cationic electrodeposition paint containing an epoxy resin, that is, a liquid (electrodeposition paint) including epoxy-based resin or epoxy-polyamide-based resin dissolved, and an electric current is applied to deposit the resin to the base member, followed by drying and heating to thereby thermally curing the resin.

Conditions of the heating temperature and time here only needs to be a temperature and time for curing the coated paint, and may be appropriately selected depending on the type of the paint. For example, the coating film can be heated at a temperature of about 200° C., but the heating is not limited to this condition.

Next, if necessary, the coating film is overbaked. The overbaking can be performed at a temperature of, for example, 250° C. or more. However, depending on the constituent material of the coating film, for example, in the case of a coating film containing an epoxy resin, special attention is required because the coating film may be thermally decomposed at 300° C. or more.

When the resin is thermally cured by drying and heating after the resin is deposited to the above-described base member, the heating can be performed at a temperature of, for example, 250° C. or more to simultaneously perform thermal curing and overbaking. Also in this case, since thermal decomposition may occur depending on the constituent material of the coating film, special attention is required for the heating temperature.

The base member according to the disclosure is a base member for a disk drive apparatus, and can be a base member for a heat-assisted magnetic recording disk drive apparatus in a preferable aspect.

Preferred embodiments of the base member of the disclosure, a spindle motor, and a disk drive apparatus provided with the spindle motor are described below with reference to the accompanying drawings. Note that various embodiments described below are exemplary embodiments of the disclosure, and the disclosure is not limited to the embodiments.

### Base Member

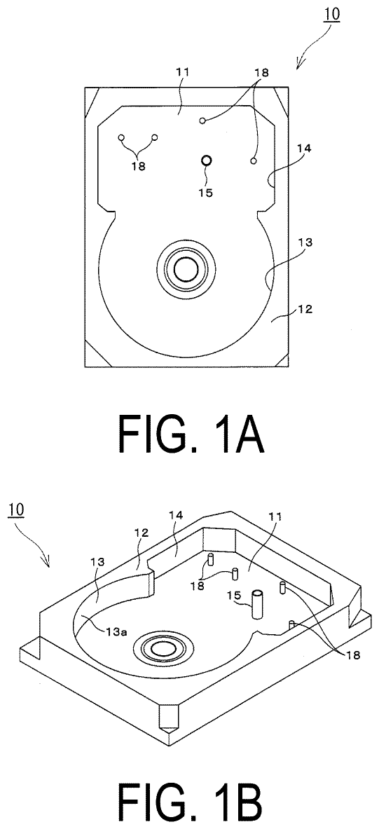

FIGS. 1A and 1B are schematic views for illustrating a configuration of a base member according to an embodiment of the disclosure, wherein FIG. 1A is a plan view and FIG. 1B is a perspective view.

As illustrated in FIGS. 1A and 1B, a base member 10 has a substantially rectangular box shape, that is, includes a rectangular plate-like bottom portion 11 having short sides and long sides, and a side wall portion 12 formed around the bottom portion 11 and extending in a direction orthogonal to the bottom portion 11. The base member 10 is generally manufactured by die casting of aluminum, and is provided with the above-mentioned predetermined coating film according to the disclosure.

The side wall portion 12 includes a circular portion 13 having an inner circumferential surface shape formed along a shape of a hard disk, and a rectangular portion 14 having a rectangular shape and configured to accommodate a mechanism for writing and reading data to and from the hard disk. In the die-casted state, inner circumferential surfaces of the circular portion 13 and the rectangular portion 14 are inclined so as to slightly expand upward, corresponding to the draft of a mold. The inner circumferential surface (disk opposing surface) of the circular portion 13 is machined to form a machined surface (machined portion) 13a orthogonal to the bottom portion 11. The machined surface 13a has a predetermined uniform distance from an outer peripheral edge of the hard disk.

In FIGS. 1A and 1B, a shaft 15 is a shaft used when the base member 10 is used in a hard disk drive apparatus, and supports 18 are supports configured to fix a data reading/writing mechanism of the hard disk drive apparatus.

As an example, screw holes may be formed at the bottom portion 11 of the base member 10, and the shaft 15 and the supports 18 may be attached to the screw holes and may be fixedly press-fitted into recess parts or through holes formed at the bottom portion 11 of the base member 10.

Alternatively, when the base member 10 is used in a hard disk drive apparatus with a low-density gas such as helium gas enclosed inside, the shaft 15 and the supports 18 may be die-casted integrally with the base member 10 to avoid leakage of the gas.

### Spindle Motor

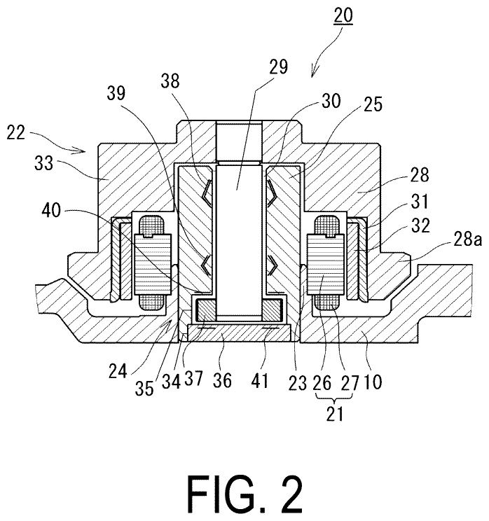

FIG. 2 is a schematic view for illustrating a spindle motor according to an embodiment of the disclosure.

As illustrated in FIG. 2, a spindle motor 20 is used as a motor for driving a data storage device including a magnetic disk, an optical disk, or the like used in a computer. As a whole, the spindle motor 20 includes a stator assembly 21 and a rotor assembly 22. Although the spindle motor 20 in FIG. 2 is a shaft rotating motor, the disclosure is also applicable to a shaft fixed motor.

The stator assembly 21 is fixed to a housing constituting a casing of the data storage device, that is, fixed to a cylindrical portion 23 provided at the base member 10 to protrude upward. A stator core 26 wound around with a stator coil 27 is fitted and attached to an outer circumferential portion of the cylindrical portion 23.

The rotor assembly 22 includes a rotor hub 28, and the rotor hub 28 is fixed to an upper end part of a shaft 29 and rotates together with the shaft 29. The shaft 29 is inserted into a sleeve 25 being a bearing member, and is rotatably supported by the sleeve 25. The sleeve 25 is fitted and fixed inside the cylindrical portion 23. A lower cylindrical portion 28a of the rotor hub 28 rotates inside the base member 10 being a housing, but a back yoke 31 is mounted on an inner circumferential surface of the lower cylindrical portion 28a, and a rotor magnet 32 is further fitted and fixed inside the back yoke 31 and is magnetized to a plurality of poles of N and S poles.

When the stator coil 27 is energized, a magnetic field is formed by the stator core 26, and this magnetic field acts on the rotor magnet 32 disposed in the magnetic field to rotate the rotor assembly 22. On an outer circumferential surface of an intermediate cylindrical portion 33 of the rotor hub 28 of the rotor assembly 22, a recording disk, for example, a magnetic disk (not illustrated) constituting a storage unit of the data storage device is mounted, and is rotated or stopped by the operation of the spindle motor 20, so that information writing and data processing are performed by a recording head (not illustrated).

In the spindle motor 20 of such an embodiment, a fluid dynamic pressure bearing 24 is provided at a portion where the sleeve 25 rotatably supports the shaft 29.

A large-diameter first recess 34 opening downward is formed at a lower end part of the sleeve 25, and a small-diameter second recess 35 is formed at a top surface of the first recess 34. A counter plate (thrust receiving plate) 36 is fitted into the large-diameter first recess 34 and fixed to the first recess 34 by a mechanism such as welding or bonding, so that the inside of the sleeve 25 is in an airtight state.

A thrust washer 37 is fitted, press-fitted and fixed to a lower end part of the shaft 29, and the thrust washer 37 is disposed in the second recess 35 of the sleeve 25 to rotate together with the shaft 29 while opposing the counter plate 36 and a top surface of the second recess 35.

A gap between the sleeve 25 and the shaft 29, a gap between the thrust washer 37 and the second recess 35, and a gap between the thrust washer 37/the shaft 29 and the counter plate 36 communicate with one another, and fluid dynamic pressure bearing oil 30 is sealed in the communication gaps. The fluid dynamic pressure bearing oil 30 is injected from between the sleeve 25 and the shaft 29.

A first radial dynamic pressure groove 38 and a second radial dynamic pressure groove 39 for generating dynamic pressure are formed at an inner circumferential surface of the sleeve 25 opposing the shaft 29 to be spaced apart from each other in an axial direction. Due to the rotation of the shaft 29, the radial dynamic pressure grooves 38 and 39 generate dynamic pressure causing the shaft 29 and the sleeve 25 to be in a non-contact state in a radial direction. A first thrust dynamic pressure groove 40 and a second thrust dynamic pressure groove 41 are formed at the top surface of the second recess 35 opposing an upper end surface of the thrust washer 37 and an upper end surface of the counter plate 36 opposing a lower end surface of the thrust washer 37, respectively. Due to the rotation of the shaft 29, the thrust dynamic pressure grooves 40 and 41 generate dynamic pressure for stably floating the shaft 29 in a thrust direction. Due to the action of the dynamic pressure grooves, the shaft 29 can stably rotate at a high speed in the non-contact state with respect to the sleeve 25. As the dynamic pressure grooves, known patterns such as herringbone grooves and spiral grooves can be used.

### Disk Drive Apparatus

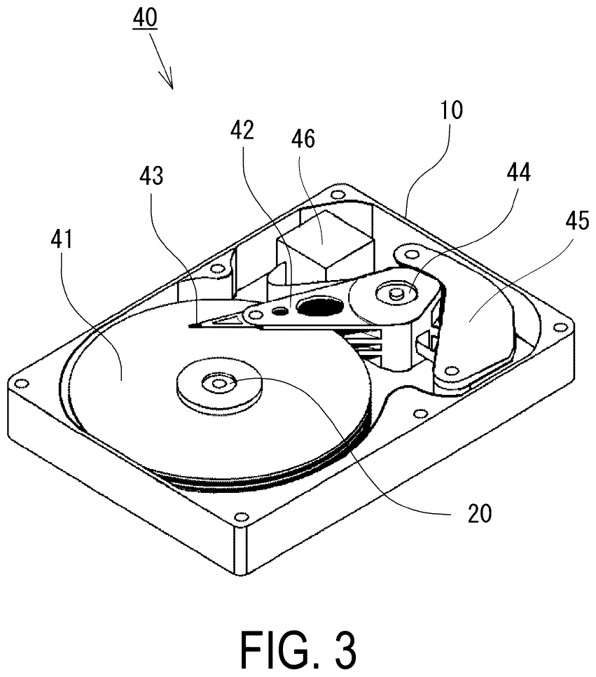

FIG. 3 is a perspective view illustrating an overall configuration of a disk drive apparatus 40 using the spindle motor according to the present embodiment.

As illustrated in FIG. 3, the disk drive apparatus 40 according to the present embodiment includes the above-described base member 10 (base plate) having a substantially rectangular box shape, the spindle motor 20 placed on the base member 10, a magnetic disk 41 rotated by the spindle motor 20, a swing arm 42 having a magnetic head 43 for writing information at a predetermined position of the magnetic disk 41 and reading information from an arbitrary position, a pivot assembly bearing device 44 for swingably supporting the swing arm 42, an actuator 45 for driving the swing arm 42, and a controller 46 for controlling the components.

The disk drive apparatus according to the disclosure also targets ones employing the heat-assisted magnetic recording (HAMR) system as a recording system. In the disk drive apparatus employing the heat-assisted magnetic recording (HAMR) system, the temperature of a head portion of an actuator may locally reach a high temperature of 400° C.

The disk apparatus can be a disk drive apparatus including nine or more magnetic disks each having a diameter of 3.5 inches, for example. In such an apparatus having a large number of disks, a spatial volume in the apparatus is further reduced.

The disclosure is not limited to the embodiment and specific examples described in the present specification, and various changes and variations can be made within the scope of the technical idea described in the claims.

### EXAMPLES

The disclosure is described below in more detail with reference to examples. However, the disclosure is not limited to the examples.

### Base Member

Cationic electrodeposition paints (1) and (2) used for the electrodeposition coating of the base member are as follows.

### Cationic Electrodeposition Paint (1)

A main emulsion produced by uniformly mixing a binder component containing an amine-modified epoxy resin, a curing agent, and the like, a pigment dispersion paste containing kaolin but not containing carbon black, deionized water, and the like were mixed to produce the cationic electrodeposition paint (1) used in Examples.

### Cationic Electrodeposition Paint (2)

The cationic electrodeposition paint (2) was prepared in the same manner as in Cationic Electrodeposition Paint (1), except that the pigment dispersion paste containing no kaolin was used.

Using the obtained cationic electrodeposition paint (1) or (2), a hard disk case made of aluminum die-cast (aluminum die-cast subjected to chemical conversion coating treatment) was subjected to electrodeposition coating to produce a coating film.

In both of the obtained electrodeposition coating films using the cationic electrodeposition paints (1) and (2), a color of aluminum as a base was confirmed.

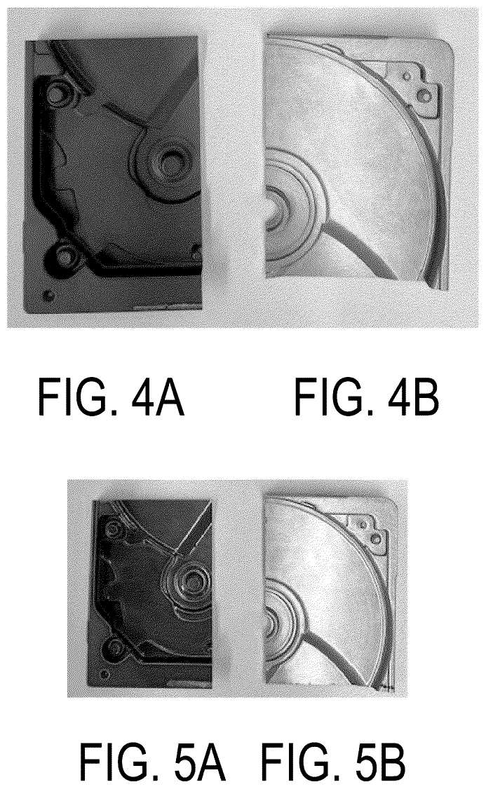

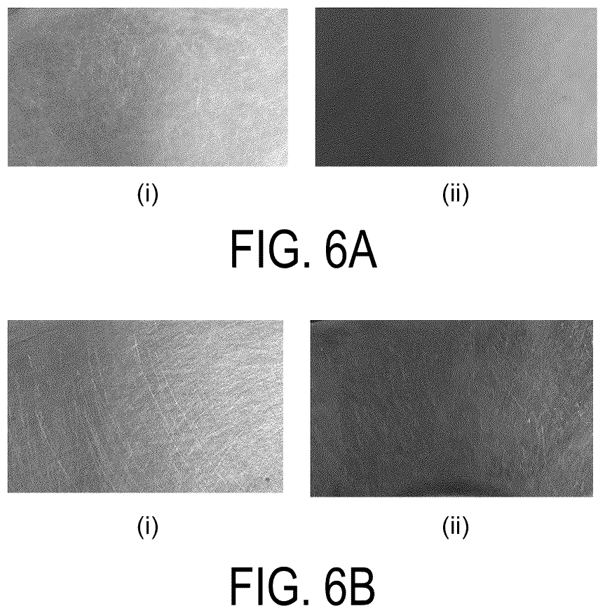

The coating film was overbaked by heating at 250° C. for three hours. The results obtained from the above are shown in FIGS. 4A to 6B. FIGS. 4A and 4B show photographs (FIG. 4A is after overbaking, and FIG. 4B is before overbaking) of a hard disk case with the cationic electrodeposition paint (1) (without carbon black) applied. FIGS. 5A and 5B show photographs (FIG. 5A is after overbaking, and FIG. 5B is before overbaking) of a hard disk case with the cationic electrodeposition paint (2) (without carbon black and extender pigment) applied. FIGS. 6A and 6B show enlarged photographs of surfaces of the respective hard disk cases. The cationic electrodeposition paint (1) is applied ((i) is before overbaking, and (ii) is after overbaking) in FIG. 6A, and the cationic electrodeposition paint (2) is applied ((i) is before overbaking, and (ii) is after overbaking) in FIG. 6B.

As shown in FIGS. 4A and 4B and FIGS. 5A and 5B, in the coating films after overbaking (FIG. 4A, FIG. 5A), the coating films were entirely colored in a dark color, and as a result, the color of aluminum as the base seen before overbaking was hidden (see FIG. 4B, FIG. 5B). It was also confirmed that the color of aluminum as the base was further hidden in an electrodeposition coated product (FIG. 6A) produced by the cationic electrodeposition paint (1) using the pigment dispersion paste containing kaolin than in an electrodeposition coated product (FIG. 6B) produced by the cationic electrodeposition paint (2) using the pigment dispersion paste containing no kaolin. It was also confirmed that gloss peculiar to metal was further suppressed in the electrodeposition coated product produced by the cationic electrodeposition paint (1) using the pigment dispersion paste containing kaolin (FIG. 4A, FIG. 5A). Setting the overbaking condition to a higher temperature (for example, 280° C.) or a longer time (for example, six hours) can improve the degree of hiding the color of the base.

The best embodiments have been described in detail above, but the disclosure is not limited to the embodiments described above, and variations, modifications, and the like within a range achieving the object of the disclosure are included in the disclosure.

While preferred embodiments of the disclosure have been described above, it is to be understood that variations and modifications will be apparent to those skilled in the art without departing from the scope and spirit of the disclosure. The scope of the disclosure. therefore, is to be determined solely by the following claims.

1. A base member at least partially covered with a coating film, wherein
the coating film is an electrodeposition coating film containing no carbon black.

2. The base member according to claim 1, wherein
the coating film is a coating film containing no coloring pigment.

3. The base member according to claim 1, wherein
the coating film is a coating film containing an epoxy resin, and the coating film is an overbaked electrodeposition coating film.

4. The base member according to claim 1, wherein
the coating film is a coating film containing an extender pigment.

5. The base member according to claim 4, wherein
the extender pigment contains kaolin.

6. The base member according to claim 1, wherein
the coating film is a coating film containing no extender pigment.

7. The base member according to claim 1, wherein
the base member is used for a magnetic recording disk drive apparatus.

8. The base member according to claim 7, wherein
the base member is used for a heat-assisted magnetic recording disk drive apparatus.

9. A spindle motor, comprising
the base member according to claim 1.

10. A disk drive apparatus, comprising
the spindle motor according to claim 9.

11. The disk drive apparatus according to claim 10, wherein
the disk drive apparatus is a heat-assisted magnetic recording disk drive apparatus.
